(19) United States
(12) Patent Application Publication
(10) Pub. No.: US 2006/0179314 A1
(43) Pub. Date: Aug. 10, 2006

(54) Key establishment method and system between wireless communication devices

(75) Inventor: Hee Jean Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/346,195

(22) Filed: Feb. 3, 2006

(30) Foreign Application Priority Data
Feb. 4, 2005 (KR) 2005-10-0010725

(51) Int. Cl. H04L 9/00

(52) U.S. Cl. 713/171

(57) ABSTRACT

A method for securely establishing a key against aggressive intervention of a third party. A first device generates a function value using a generator, which is selected from elements in a finite field, and an arbitrary number, which is less than a number of the elements of the finite field, hashes the function value, thereby generating a hashed value, and sends the hashed value and the function value to a second device. The second device hashes the received function value, and establishes a key using the received function value and another arbitrary number selected from the elements of the finite field when the hashed function value matches the received hashed value. Accordingly, it is possible to prevent a third device from intervening in their key establishment. Furthermore, a separate channel for the key establishment is not required because the key is established over a data communication channel.

### CROSS-REFERENCE TO RELATED APPLICATIONS

This application claims priority under 35 U.S.C. § 119 (a) from Korean Patent Application No. 10-2005-0010725 filed on Feb. 4, 2005, in the Korean Intellectual Property Office, the entire disclosure of which is incorporated herein by reference.

### BACKGROUND OF THE INVENTION

1. Field of the Invention

Methods and systems consistent with the present invention relate to key establishment for communication between wireless network devices, more particularly, to a method and a system for securely establishing a key against attacks or intervention by other devices.

2. Description of the Related Art

Devices in a wireless network establish keys for secure communications against attacks by a third party. The devices encrypt data using the established keys and send the encrypted data so that the data can be transmitted and received securely against attacks by a third party.

In the following, conventional key establishment methods are explained with respect to devices of a wireless network, particularly, an ad-hoc network.

First, the devices can establish keys via a channel other than a channel used for data transmission. That is, the keys can be established using infrared rays or cables. Since the devices are located in a short transmission distance, intervention by a third party can be blocked. Yet, only the devices in the short transmission distance are able to establish the key.

The devices can establish the key by use of the direct contact to a human body as a channel. In detail, when the devices touch the human body, the key can be established using a current flowing through the human body. However, such a method requires a separate channel in addition to a communication channel.

Secondly, ZigBee Alliance suggested the Unsecure Key Establishment (UKE) protocol to save cost. However, according to the UKE protocol, a third party can acquire the key without aggressive intervention.

Thirdly, a public key can be utilized to transmit and receive data between a transmitting device and a receiving device. Data encryption and decryption using the public key require a large amount of computations. But, a small amount of computations is processable to devices in an ad-hoc network.

RSA is a cryptography system developed by Rivest, Shamir, and Adleman. The RSA takes advantage of a feature that it is hard to factor a large integer. The RSA is the most prevalent system nowadays. Meanwhile, the factorization using an elliptical curve has been found out and an RSA attack method by factoring a 512-bit number has been discovered. Thus, a 1024-bit key is used since a secure RSA cryptography system can be constructed only when a modulus n is selected to be a large number. In such a generalized RSA cryptography system, when the computation speeds up, the key needs to be lengthened and thus a time required for the encryption and the decryption is increased. In addition, exponentiation, which carries out iterative multiplications, slows down the encryption and decryption of the data.

A Diffie and Hellman (DH) protocol is adoptable in lieu of the above conventional methods. The DH protocol is a cryptography system based on a discrete logarithm problem in a finite field. The DH protocol takes advantage of a property that it is hard to obtain x that satisfies α^{x}=β when α and β are given in the finite field (e.g., Zp). The DH protocol features the ensured security even when the size of the key is reduced in comparison with the RSA cryptography system. FIG. 1 illustrates a key establishment method between devices according to the DH protocol.

In FIG. 1, a device A and a device B intend to establish a key therebetween, and a device C is a third device. The devices A and B set a finite field and a generator, to be explained later, to establish the key.

The devices A and B select an arbitrary number that is smaller than the number of elements in the finite field. Referring to FIG. 1, the arbitrary number, which is device A, is x, and the arbitrary number selected by the device B is y. The device A generates a function value using the selected arbitrary number and the generator g, that is, acquires g^{x}. Likewise, the device B generates a function value using the selected arbitrary number and the generator g, that is, acquires g^{y}

The device A provides the acquired value g^{x} to the device B. If the device C is placed in vicinity of the device A, the device C is likely to receive the output value from the device A. The device B also provides the acquired value g^{y} to the device A. If the device C is placed in vicinity of the device B, the device C is likely to receive the output value from the device B.

The device A creates its key by combining the received g^{y} and its selected arbitrary number. The key created by the device A is (g^{y})^{y}. Likewise, the device B creates its key (g^{x})^{y} by combining the received g^{x} and its selected arbitrary number. As the finite field holds the commutative law, the device A and the device B establish the same key.

To acquire (g^{x})^{y} of the device A and the device B, the device C needs to obtain x from the received g^{x} or y from the received g^{y}. However, according to the characteristic of the discrete log problem, it is difficult to obtain x from g^{x} or y from g^{y}. Thus, the device C cannot obtain (g^{x})^{y} of the device A and the device B.

FIG. 2 illustrates a problem when the device C aggressively intervenes in the key establishment between the device A and the device B.

It is assumed that the device A requests the key establishment from the device B, or the device B requests the key establishment from the device A. When the device A requests the key establishment to the device B, the device C intervenes, pretends to be the device B, and responds to the device A. As to the device B, the device C pretends to be the device A and requests the key establishment. Note that it is true for the case when the device B requests the key establishment from the device A.

The device A selects an arbitrary number x, and the device C selects an arbitrary number u for the key establishment with the device A. The device B selects an arbitrary number y, and the device C selects an arbitrary number v for the key establishment with the device B. The device A generates a function value using the selected arbitrary number and a generator g. That is, the device A obtains g^{x}. Likewise, the device B generates a function value g^{y} using the selected arbitrary number and a generator g. The device C obtains g^{u} and g^{v}.

The device A provides the obtained value g^{x} to the device C. The device B provides the obtained value g^{y} to the device C. The device C provides the obtained value g^{u} to the device A and the obtained value g^{v} to the device B.

The device A creates its key (g^{u})^{x} by combining the received g^{u} and its arbitrary number. The device B also creates its key (g^{v})^{y} by combining the received g^{v} and its arbitrary number. The device C creates its keys (g^{x})^{u} and (g^{y})^{v} by combining the received g^{x} and g^{y} with its arbitrary number.

As such, the device C aggressively intervenes in the key establishment between the device A and the device B and thus acquires their keys. In this situation, the device A mistakes the device C for the device B and communicates with the device C. The device B also mistakes the device C for the device A and communicates with the device C. Therefore, a novel method is demanded for the devices A and B to establish a secure key against the device C which is a third party.

### SUMMARY OF THE INVENTION

An aspect of the present invention provides a method for securely establishing a key against an aggressive intervention of a third party.

Another aspect of the present invention provides a method for establishing a key via a data communication channel.

Still another aspect of the present invention provides a method for reducing an amount of computations required for the encryption and the decryption using a key.

To achieve the above aspects of the present invention, a key establishment method includes selecting a generator from elements of a finite field, and an arbitrary number less than a number of the elements of the finite field, generating a function value using the selected arbitrary number and the selected generator, hashing the function value, and receiving the hashed value; hashing the received function value and determining whether the hashed function value matches the received hashed value; and establishing a key using the received function value and the selected element when the hashed function value matches the received hashed value.

In accordance with the aspects of the present invention, a key establishment system includes a first device which generates a function value using a generator, which is selected from elements in a finite field, and an arbitrary number, which is less than a number of the elements of the finite field, hashes the function value, and sending the hashed value and the function value; and a second device which hashes the received function value, and establishes a key using the received function value and an arbitrary number selected from the elements of the finite field when the hashed function value matches the received hashed value.

### BRIEF DESCRIPTION OF THE DRAWING FIGURES

The above and other aspects of the invention will become apparent and more readily appreciated from the following description of exemplary embodiments, taken in conjunction with the accompanying drawing figures, in which:

FIG. 1 illustrates a conventional key establishment method between devices over a wireless network;

FIG. 2 illustrates a problem which may occur during the conventional key establishment of FIG. 1;

FIG. 3 illustrates a key establishment method between devices over a wireless network according to an exemplary embodiment of the present invention; and

FIG. 4 illustrates a calculation of a data speed, which is applied to an exemplary embodiment of the present invention, over the wireless network.

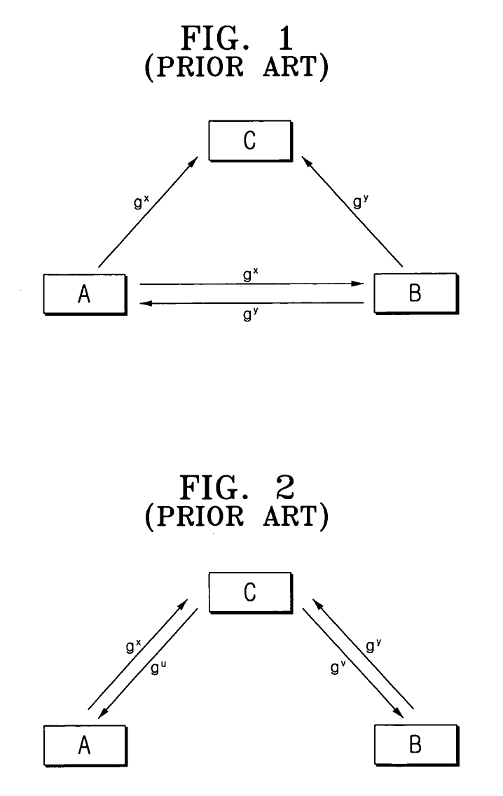

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

A finite field and a generator are first explained prior to the illustration of the present invention. In the following equation, the finite field has seven elements.
Zp=(0,1,2,3, . . . ,p−1) [Equation 1]

p is a prime number. When p is a prime number, Zp, which is a set of remainders of division by p, forms a finite field. For example, as for p=7, Z₇=(0,1,2,3,4,5,6). Table 1 shows the addition (a+b) of Z₇ where p=7.

TABLE 1

| | | A | | | | | | |
|---|---|---|---|---|---|---|---|---|
| | | 0 | 1 | 2 | 3 | 4 | 5 | 6 |
| B | 0 | 0 | 1 | 2 | 3 | 4 | 5 | 6 |
| | 1 | 1 | 2 | 3 | 4 | 5 | 6 | 0 |
| | 2 | 2 | 3 | 4 | 5 | 6 | 0 | 1 |
| | 3 | 3 | 4 | 5 | 6 | 0 | 1 | 2 |
| | 4 | 4 | 5 | 6 | 0 | 1 | 2 | 3 |
| | 5 | 5 | 6 | 0 | 1 | 2 | 3 | 4 |
| | 6 | 6 | 0 | 1 | 2 | 3 | 4 | 5 |

Table 2 shows the multiplication (a×b) of Z₇ where p=7.

TABLE 2

A

| | | 1 | 2 | 3 | 4 | 5 | 6 |
|---|---|---|---|---|---|---|---|
| b | 1 | 1 | 2 | 3 | 4 | 5 | 6 |
| | 2 | 2 | 4 | 6 | 1 | 3 | 5 |
| | 3 | 3 | 6 | 2 | 5 | 1 | 4 |
| | 4 | 4 | 1 | 5 | 2 | 6 | 3 |
| | 5 | 5 | 3 | 1 | 6 | 4 | 2 |
| | 6 | 6 | 5 | 4 | 3 | 2 | 1 |

Table 3 shows the exponentiation (b^{a}) of Z₇ where p=7.

TABLE 3

A

| | | 1 | 2 | 3 | 4 | 5 | 6 |
|---|---|---|---|---|---|---|---|
| B | 1 | 1 | 1 | 1 | 1 | 1 | 1 |
| | 2 | 2 | 4 | 1 | 2 | 4 | 1 |
| | 3 | 3 | 2 | 6 | 4 | 5 | 1 |
| | 4 | 4 | 2 | 1 | 4 | 2 | 1 |
| | 5 | 5 | 4 | 6 | 2 | 3 | 1 |
| | 6 | 6 | 1 | 6 | 1 | 6 | 1 |

The generator is now explained. The generator is b having different values of b^{a} where a ranges from 1 to 6. As noted in Table 3, the generator is 3 and 5.

Hereafter, a key establishment method of a device according to an exemplary embodiment of the present invention is elucidated in reference to the attached figures. The key establishment method can reduce a key establishment time and block intervention of a third party.

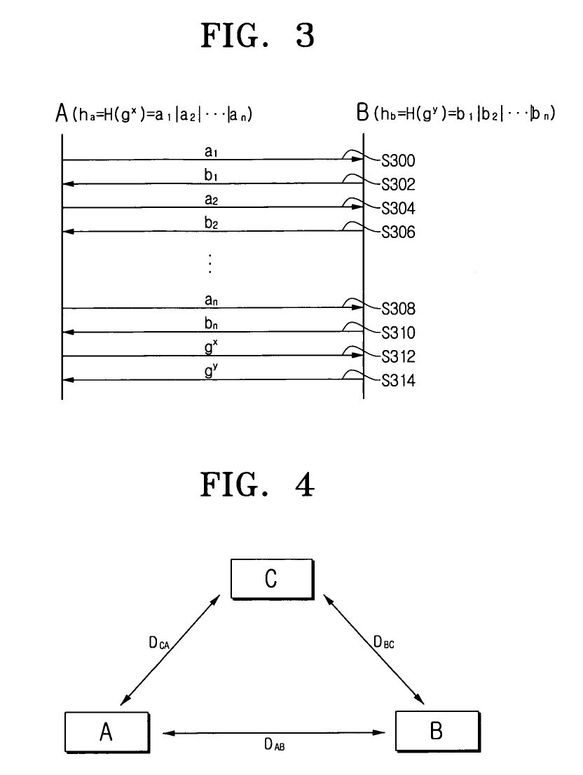

FIG. 3 illustrates a key establishment method between devices according to an exemplary embodiment of the present invention, which is described below in detail.

A device A sets one generator of elements in the finite field, and selects an arbitrary number less than the number of the elements in the finite field. For example, let the arbitrary number selected by the device A be x. The device A generates a function value using the selected arbitrary number and the set generator. The function value is g^{x}. The device A conducts a hash operation with respect to the function value based on Equation 2
hₐ=H(g^{x})=a₁|a₂|a₃| . . . |aₙ [Equation 2]

Likewise, a device B selects an arbitrary number less than the number of elements in the finite field. For example, let the arbitrary number of the device B be y. The device B generates a function value using the selected arbitrary number and a preset generator. The function value is g^{y}. The device B hashes the function value based on Equation 3.
h_{b}=H(g^{y})=b₁|b₂|b₃| . . . |bₙ [Equation 3]

To reduce the size of the hashed value transmitted, generally, the device A and the device B may set n to an arbitrary number greater than 32.

How to establish the key is now elucidated in reference to FIG. 3.

The device A sends a first bit of its hashed value to the device B (S300). The device B sends a first bit of its hashed value to the device A (S302). The device A sends a second bit of the hashed value to the device B (S304). The device B sends a second bit of the hashed value to the device A (S306). The device A sends a final bit of the hashed value to the device B (S308). The device B sends a final bit of the hashed value to the device A (S310). The device A sends its function value g^{x} to the device B (S312). The device B sends its function value g^{y} to the device A (S314).

Next, the device A compares the hashed value of the received function value g^{y}, with the bits received in operations S302, S306, and S310. When the two compared values match according to a result of the comparison, the device A generates its key by combining g^{y} and the selected arbitrary number. As a result, the key (g^{y})^{x} is generated by the device A. In contrast, when the two values do not match, the device A learns that g^{y} is forged by the device C. The device B compares the hashed value of the received function value g^{x}, with the bits received in operations S300, S304, and S308. When the two compared values match according to a result of the comparison, the device B generates its key by combining g^{x} and the selected arbitrary number. As a result, the key (g^{x})^{y} is generated by the device B. In contrast, when the two values do not match, the device B learns that g^{x} is forged by the device C. Through the above procedure, the device A and the device B can establish the identical key.

Although FIG. 3 depicts that the device A and the device B send the bit value or the function value in an alternating manner, substantially, the devices A and B send the bit value or the function value independently from each other.

According to an exemplary embodiment of the present invention, the number of transmitted bits is reduced to shorten the key establishment time. It is expected that the data speed of the wireless communication is to reach several Gbps through tens of Gbps in the near future in consideration of the advances of technologies. Provided that the data speed of the wireless network is 1 Gbps, a radio wave travels a distance during a time taken to send one bit in accordance with Equation 4.
λ=c/ƒ=(3×10⁸)/(1×10⁹)=30cm [Equation 4]

In Equation 4, since a clock interval is 30 cm, the distance to transmit one bit is 30 cm. Accordingly, transmission of 32-bit data requires a distance of 960 cm. The device C, which is placed outside 960 cm from the devices A and B, is not able to intervene in the key establishment between the device A and the device B.

FIG. 4 illustrates a calculation of a data speed, which is applied to the present invention, over the wireless network.

First, a constant used to calculate the data speed is set forth. Tu is a time taken to send one bit, and c is the speed of light. D_{AB} is a distance between the device A and the device B, D_{BC} is a distance between the device B and the device C, and D_{CA} is a distance between the device C and the device A. n is bits of the hash function. To establish the keys between the device A and the device B, Equation 5 should be satisfied.
c⁻¹×(D_{BC}+D_{CA})≧n×Tu+c⁻¹×D_{AB} [Equation 5]

c⁻¹×(D_{BC}+D_{CA}) denotes a time taken to send the first bit of the hash function from the device A to the device B via the device C. In other words, c⁻¹×(D_{BC}+D_{CA}) denotes a time required for the device C to intervene in the key establishment between the device A and the device B. n×Tu denotes a difference of the transmission time between the first bit and the final bit of the hash function. c⁻¹×D_{AB} denotes a time taken to send the first bit of the hash function from the device A to the device B. Equation 5 takes account of n×Tu in order to completely block the intervention of the device C. In other words, prior to the reception of the first bit of the hash function from the device C, the device B should receive the final bit of the hash function from the device A.

Provided that D_{AB} converges to zero, Equation 5 can be expressed as Equation 6.
Tu≦2R/(n×c) [Equation 6]

R is the distance between the device A and the device C, or, the distance between the device B and the device C. Provided that the hash function has 32 bits and R=1, Tu can be expressed as Equation 7.
Tu≦2×10⁻¹⁰ [Equation 7]

When the data speed exceeds 50 Gbps in the wireless network, a user can be assured that no other device is physically present within 30 cm. Thus, the key establishment method according to an exemplary embodiment of the present invention can be applied.

In the light of the foregoing as set forth, the device A and the device B that intend to establish a key therebetween, encrypt and send a key using a hash function so as to prevent a third device C from intervening in their key establishment. As a result, the device C cannot participate in the key establishment between the devices A and B. Furthermore, a separate channel for the key establishment is not required because the key is established over a data communication channel.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A key establishment method comprising:
selecting a generator from elements of a finite field, and an arbitrary number less than a number of the elements of the finite field, generating a function value using the selected arbitrary number and the selected generator, hashing the function value, thereby generating a hashed value, sending the hashed value and the function value, and receiving another hashed value and another function value;
hashing the received other function value and determining whether the hashed other function value matches the received other hashed value; and
establishing a key using the received other function value and the selected arbitrary number when the hashed other function value matches the received other hashed value.

2. The key establishment method of claim 1, wherein the hashed value is at least 32 bits.

3. The key establishment method of claim 1, wherein when the selected arbitrary number is x and the generator is g, the function value is g^{x}.

4. The key establishment method of claim 3, wherein a number of bits of the g^{x} is greater than a number of bits of the hashed value.

5. The key establishment method of claim 3, wherein when the selected arbitrary number is y, the established key is (g^{x})^{y}.

6. The key establishment method of claim 1, wherein a data speed in a network using the established key is 1 Gbps or higher.

7. The key establishment method of claim 6, wherein a minimum data speed for the key establishment is calculated based on an equation:
ƒ=(D_{b}+D_{c}−Dₐ)/(c×n)
where Dₐ is a distance between a first device and a second device intending to establish a key therebetween, D_{b} and D_{c} is a distance between a third party, which intervenes in the key establishment, and the first device and a distance between the third party and the second device, respectively, ƒ is the minimum data speed, c is the speed of light, and n is a number of bits of the hashed value.

8. The key establishment method of claim 7, where n is set to an arbitrary number greater than 32.

9. A key establishment system comprising:
a first device which generates a function value using a generator which is selected from elements in a finite field, and an arbitrary number which is less than a number of the elements of the finite field, hashes the function value, thereby generating a hashed value, and sends the hashed value and the function value to a second device; and
the second device which hashes the received function value, and establishes a key using the received function value and another arbitrary number selected from the elements of the finite field when the hashed function value matches the received hashed value.

10. The key establishment system of claim 9, wherein the second device generates another function value using the selected other arbitrary number and the generator, hashes the function value, thereby generating another hashed value, and sends the other hashed value and the other function value to the first device.

11. The key establishment system of claim 10, wherein the first device hashes the received other function value, and establishes a key using the received other function value and the selected arbitrary number when the hashed other function value matches the received other hashed value.

12. The key establishment system of claim 9, wherein the hashed value is at least 32 bits.

13. The key establishment system of claim 9, wherein when the selected arbitrary number is x and the generator is g, the first device generates the function value g^{x}.

14. The key establishment system of claim 13, wherein the first device generates g^{x} and a number of bits of g^{x} is greater than a number of bits of the hashed value.

15. The key establishment system of claim 13, wherein when the selected arbitrary number is y, the second device establishes a key (g^{x})^{y}.

16. The key establishment system of claim 9, wherein the first and second devices are configured to transmit data to each other at a speed of 1 Gbps or higher.

17. The key establishment system of claim 16, wherein a minimum data speed of the key establishment system is calculated based on an equation:
ƒ=(D_{b}+D_{c}−Dₐ)/(c×n)
where Dₐ is a distance between the first device and the second device, D_{b} and D_{c} is a distance between a third party which intervenes in the key establishment, and each of the first and second devices, ƒ is the minimum data speed, c is the speed of light, and n is a number of bits of the hashed value.

18. The key establishment system of claim 17, wherein n is set to an arbitrary number greater than 32.

19. The key establishment method of claim 6, wherein the hashed value and the function value are sent at a speed of 1 Gbps or higher.

20. The key establishment system of claim 16, wherein the first device communicates with the second device at a speed of 1 Gbps or higher.
